(19) United States
(12) Patent Application Publication
(10) Pub. No.: US 2015/0176524 A1
(43) Pub. Date: Jun. 25, 2015

(54) PISTON FOR AN INTERNAL COMBUSTION ENGINE

(71) Applicant: MAHLE International GmbH, Stuttgart (DE)

(72) Inventor: Timo Linke, Stuttgart (DE)

(73) Assignee: MAHLE International GmbH, Stuttgart (DE)

(21) Appl. No.: 14/415,197

(22) PCT Filed: Jul. 18, 2013
(86) PCT No.: PCT/DE2013/000403

§ 371 Date: Jan. 16, 2015

(30) Foreign Application Priority Data
Jul. 18, 2012 (DE) 10 2012 014 188.2

(51) Int. Cl. F02F 3/22; F02F 3/00

(52) U.S. Cl. CPC F02F 3/22; F02F 3/0015

(57) ABSTRACT

The present invention relates to a piston (10, 110) for an internal combustion engine having a piston head (13, 113) and a piston skirt (14, 114), the piston (10, 110) comprising a piston base (11, 111) and a piston ring element (12, 112). The invention is characterized in that the piston base (11, 111) has a combustion recess (21, 121) which is radially offset and/or tilted relative to the center axis (M) of the piston (10, 110), a portion (19a) of a piston crown and the piston skirt (14, 114), in that the piston ring element (12, 112) has a portion (19b) of a piston crown, a circumferential fire land (22, 122) and a circumferential ring section (23, 123) with ring grooves, in that the piston base (11, 111) and the piston ring element (12, 112) form a circumferential cooling channel (24, 124) that extends between an outer lateral surface (25, 125) in the region of the combustion recess (21, 121) and an inner lateral surface (26, 126) in the region of the ring section (23, 123), in that the piston base (11, 111) and the piston ring element (12, 112) have a circumferential seam (28, 128) in the region of the piston crown (19a, 19b), via which they are non-detachably connected to one another.

The present invention relates to a piston for an internal combustion engine, having a piston head and a piston skirt, wherein the piston has a piston base body and a piston ring element.

German patent application DE 10 2011 111 319.7 discloses a piston having a reduced construction height, which piston is composed of a piston base body and a piston ring element and has a combustion bowl, wherein the piston base body and the piston ring element have a circumferential joining seam in the region of the combustion bowl, by way of which seam they are non-releasably connected with one another.

It is problematic, in this connection, that this piston structure makes the production of a piston having a non-centered (asymmetrical) combustion bowl difficult or actually impossible. For this purpose, not only the piston base body but also the piston ring element themselves would have to be configured asymmetrically in those structure regions that form the asymmetrical structure in the finished piston, with perfect coordination with one another.

The task of the present invention consists in further developing a piston of the stated type in such a manner that a piston having an asymmetrical structure of the combustion bowl can be produced using the simplest possible means.

The solution consists in that the piston base body has a combustion bowl that is offset and/or tilted relative to the center axis of the piston, a portion of a piston crown, as well as the piston skirt, that the piston ring element has a portion of a piston crown, a circumferential top land, and a circumferential ring belt provided with ring grooves, that the piston base body and the piston ring element form a circumferential cooling channel that is formed between a wall region of the combustion bowl and a wall region of the ring belt, and that the piston base body and the piston ring element have a circumferential joining seam in the region of the piston crown, by way of which seam they are non-releasably connected with one another.

The idea according to the invention consists in providing a piston with a piston ring element configured as a separate component, wherein the circumferential cooling channel is formed in part by the piston base body and in part by the piston ring element, and wherein the joining seam is disposed in the region of the piston crown. This embodiment makes it possible, without problems, to produce a piston having a combustion bowl that is radially offset and/or tilted relative to the center axis of the piston, because the combustion bowl is completely formed by the piston base body. It is therefore possible to connect a piston base body having such an asymmetrical configuration with a piston ring element having rotation symmetry. Furthermore, the piston base body and the piston ring element can be worked on separately in the region of the subsequent cooling channel, in such a manner that the inner structure of the cooling channel and thereby its cooling effect can be adapted to the most varied requirements of modern internal combustion engines.

Advantageous further developments are evident from the dependent claims.

The embodiment of the piston according to the invention makes it possible to dispose the combustion bowl offset relative to the center axis of the piston by up to 3 mm, something that was not possible in the previous embodiment of the piston.

If the combustion bowl is disposed to be tilted relative to the center axis of the piston, the center axis of the combustion bowl can enclose an acute angle α of up to 10° with the center axis of the piston.

Preferably, the joining seam disposed in the region of the piston crown runs parallel to the center axis of the piston.

An inner wall of the cooling channel can run parallel to the center axis of the piston. If the combustion bowl is disposed tilted relative to the center axis of the piston, the inner wall of the cooling channel can also run parallel to the center axis of the combustion bowl. In this way, the cooling effect of the cooling channel is optimized.

Additionally, at least one heat conducting element can be provided in the cooling channel, which element gives off a particularly great heat output to the cooling oil in the cooling channel, at the combustion bowl or at the piston crown, in targeted manner. In this way, the regions of the piston according to the invention that are under particularly great heat stress are preferentially cooled.

A preferred further development provides that a circumferential recess is formed between the piston head and the piston skirt. Such a piston, having a thermally uncoupled skirt, is characterized by a great ability to withstand stress. In the case of this piston, the cooling channel is closed off with a closure element, in known manner. Positioning of the joining seam in the region of the piston crown furthermore has the advantage, in the case of a piston having a thermally uncoupled skirt, that when the piston base body and the piston ring element are joined, welding residues that might occur (for example globules of weld material during the course of a laser welding process) do not remain adhering to the subsequent cooling channel, but rather can exit from the opening of the cooling channel, which has not been closed yet.

The closure element of a piston having a thermally uncoupled skirt is preferably held on the piston ring element in the region of the ring belt, where it can be attached in particularly simple manner.

Exemplary embodiments of the present invention will be explained in greater detail below, using the attached drawings. These show, in a schematic representation, not true to scale:

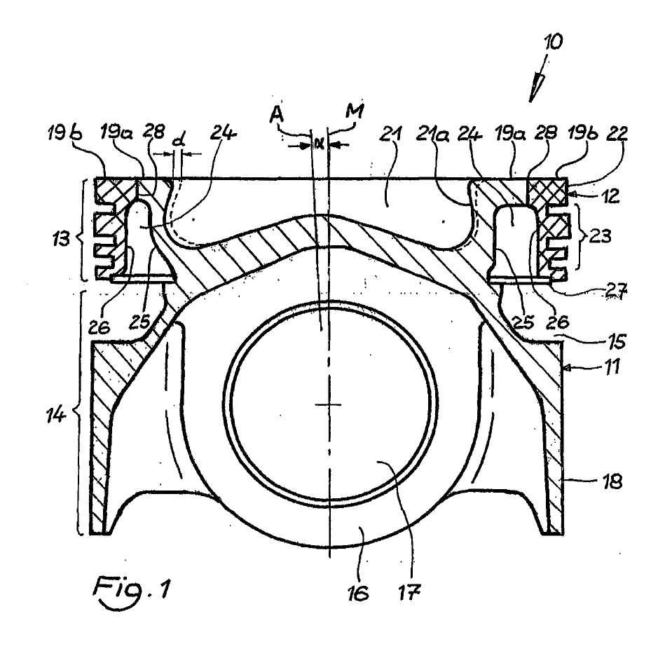

FIG. 1 a first exemplary embodiment of a piston according to the invention in section;

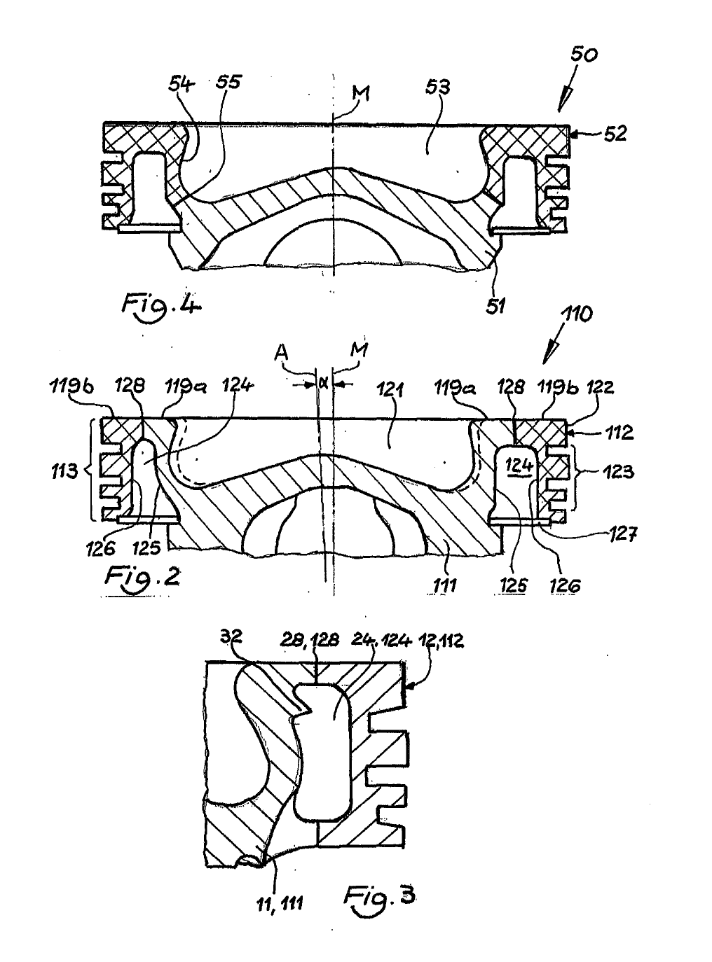

FIG. 2 an partial representation of a further exemplary embodiment of a piston according to the invention in section;

FIG. 3 an enlarged partial representation of a further exemplary embodiment of a piston according to the invention in section;

FIG. 4 a partial representation of a piston according to the state of the art in section.

FIG. 1 shows a particularly preferred exemplary embodiment of a piston 10 according to the invention. The piston 10 has a piston base body 11 and a piston ring element 12. Both components can consist of any desired metallic material that is suitable for joining of the components. The piston base body 11 and the piston ring element 12 together form the piston head 13 and the piston skirt 14 of the piston 10. In the exemplary embodiment, the piston 10 is a piston having what is called a thermally uncoupled piston skirt, i.e. a circumferential recess 15 is provided between the piston head 13 and the piston skirt 14. However, the present invention can also be used for pistons without a thermally uncoupled piston skirt.

The piston skirt 14, in known manner, has pin bosses 16 having pin bores 17 for accommodating a piston pin (not shown), as well as working surfaces 18 that connect the pin bosses 16.

The piston base body 11 furthermore forms an inner portion 19a of a piston crown as well as a combustion bowl 21 in the region of the piston head 13. According to the invention, the combustion bowl 21 is radially offset relative to the center axis M of the piston 10. To make this clear, the placement of a combustion bowl that is not offset in the piston head 13 is indicated with a dot-dash line. The radial offset d can amount to as much as 3 mm. In addition, the combustion bowl 21 is tilted relative to the center axis M of the piston 10. This has the result that the center axis M of the piston 10 and the center axis A of the combustion bowl 21 enclose an acute angle α of preferably up to 10°. The radial offset d furthermore brings about the result that the inner portion 19a of the piston crown varies in its radial width in the circumferential direction. Furthermore, the radial thickness of the vertical wall 21a of the combustion bowl 21 can vary in the circumferential direction. Of course, the piston according to the invention can also have a combustion bowl that is merely offset relative to the center axis M of the piston or merely tilted about the center axis M of the piston.

The piston ring element 12 forms an outer portion 19b of the piston crown in the region of the piston head 13 and furthermore has a circumferential top land 22 and a circumferential ring belt 23 for accommodating piston rings (not shown).

The piston base body 11 and the piston ring element 12 together form a circumferential cooling channel 24 that is formed between an outer mantle surface 25 in the region of the combustion bowl 21 and an inner mantle surface 26 in the region of the ring belt 23. Because the exemplary embodiment shown here involves a piston having a thermally uncoupled piston skirt, the cooling channel 24 is closed off with a closure element 27, in known manner. In the exemplary embodiment, the closure element 27 is held on the piston ring element 12 in the region of the ring belt 15.

Because of the radial offset d of the combustion bowl 21, the cross-section of the cooling channel 24 varies in size in the circumferential direction. One inner wall or both inner walls of the cooling channel 24 can run parallel to the center axis M of the piston 10, as shown in FIG. 1. However, at least one inner wall of the cooling channel 24 can also run parallel to the center axis A of the combustion bowl 21.

In the exemplary embodiment shown in FIG. 1, the piston ring element 12 is configured to be completely symmetrical, i.e. with rotation symmetry. The radial width of the outer portion 19b of the piston crown is constant in the circumferential direction. This means that such a piston ring element 12 can be combined with piston base bodies that are configured asymmetrically to varying degrees.

The piston base body 11 and the piston ring element 12 are connected with one another by means of joining, in the exemplary embodiment preferably by means of laser welding. As a result, a joining seam 28 is formed between the inner portion 19a and the outer portion 19b of the piston crown, which seam runs parallel to the center axis M of the piston 10 in this particularly preferred exemplary embodiment.

FIG. 2 shows a partial representation of the piston head 113 of a further exemplary embodiment of a piston 110. In this piston 110, too, the piston base body 111 forms an inner portion 119a of the piston crown as well as the combustion bowl 121 in the region of the piston head 113, which is also radially offset relative to the center axis M of the piston 110 and tilted relative to the center axis M of the piston 110. The radial offset d can amount to as much as 3 mm. The center axis M of the piston 110 and the center axis A of the combustion bowl 121 can enclose an acute angle α of preferably up to 10°. In the case of this piston 110, too, the inner part 119a of the piston crown varies in its radial width in the circumferential direction. Furthermore, the radial thickness of the vertical wall 121a of the combustion bowl 121 can vary in the circumferential direction.

The piston ring element 112 forms an outer portion 119b of the piston crown in the region of the piston head 113, and furthermore has a circumferential top land 122 and a circumferential ring belt 123 for accommodating piston rings (not shown).

The piston base body 111 and the piston ring element 112 together form a circumferential cooling channel 124, which is formed between an outer mantle surface 125 in the region of the combustion bowl 121 and an inner mantle surface 126 in the region of the ring belt 123. Because the exemplary embodiment shown here involves a piston having a thermally uncoupled piston skirt, the cooling channel 124 is closed off with a closure element 127, in known manner. In the exemplary embodiment, the closure element 127 is held on the piston ring element 112 in the region of the ring belt 115.

Because of the radial offset d of the combustion bowl 121, the cross-section of the cooling channel 124 varies in size in the circumferential direction. One inner wall or both inner walls of the cooling channel 124 can run parallel to the center axis M of the piston 110, as shown in FIG. 2. However, at least one inner wall of the cooling channel 124 can also run parallel to the center axis A of the combustion bowl 121.

The piston base body 111 and the piston ring element 112 are connected with one another by means of joining, preferably by means of laser welding. As a result, a joining seam 128 is formed between the inner portion 119a and the outer portion 119b of the piston crown, which seam runs parallel to the center axis M of the piston 110 in this particularly preferred exemplary embodiment.

In the exemplary embodiment shown in FIG. 2, the piston ring element 112 is also configured asymmetrically. This means that the radial width of the outer portion of the piston crown 119b varies in the circumferential direction.

To clarify the present invention, in FIG. 4 a piston 50 according to the state of the art is shown, which also is composed of a piston base body 51 and a piston ring element 52. In this piston, the joining seam 55 lies between these two components in the wall region 54 of the combustion bowl 53. This structure makes it at least significantly more difficult to produce a piston 10, 110 having an offset and/or tilted combustion bowl 21, 121, as it is shown as an example in FIGS. 1 and 2.

The configuration of the piston 10, 110 according to the invention makes it possible to vary the interior of the subsequent cooling channel 24, 124 before the piston base body 11, 111 and the piston ring element 12, 112 are joined, in order to bring about an optimal cooling oil flow and improve the cooling output.

FIG. 3 shows an exemplary embodiment of a cooling channel 24, 124 in which a heat conducting element 32 is formed, which brings about preferential heat conduction in the region of the top land, in the direction of the cooling channel 24, 124. The heat conducting element 32 can be formed in one piece with the piston base body during forming, for example forging, or can be firmly affixed, for example welded, onto the outer surface of the piston base body 11, 111 before the piston base body 11, 111 and the piston ring element 12, 112 are joined.

1. Piston (10, 110) for an internal combustion engine, having a piston head (13, 113) and a piston skirt (14, 114), wherein the piston (10, 110) has a piston base body (11, 111) and a piston ring element (12, 112), wherein
the piston base body (11, 111) has a combustion bowl (21, 121) that is radially offset and/or tilted relative to the center axis (M) of the piston (10, 110), a portion (19a) of a piston crown, as well as the piston skirt (14, 114),
the piston ring element (12, 112) has a portion (19b) of a piston crown, a circumferential top land (22, 122), and a circumferential ring belt (23, 123) provided with ring grooves,
the piston base body (11, 111) and the piston ring element (12, 112) form a circumferential cooling channel (24, 124) that is formed between an outer mantle surface (25, 125) in the region of the combustion bowl (21, 121) and an inner mantle surface (26, 126) in the region of the ring belt (23, 123),
the piston base body (11, 111) and the piston ring element (12, 112) have a circumferential joining seam (28, 128) in the region of the piston crown (19a, 19b), by way of which seam they are non-releasably connected with one another.

2. Piston according to claim 1, wherein the combustion bowl (21, 121) is disposed offset by up to 3 mm relative to the center axis (M) of the piston (10, 110).

3. Piston according to claim 1, wherein center axis (A) of the combustion bowl (21, 121) encloses an acute angle (α) of up to 10° with the center axis (M) of the piston (10, 110).

4. Piston according to claim 1, wherein the joining seam (28, 128) runs parallel to the center axis (M) of the piston (10, 110).

5. Piston according to claim 1, wherein an inner wall of the cooling channel (24, 124) runs parallel to the center axis (M) of the piston (10, 110).

6. Piston according to claim 5, wherein an inner wall of the cooling channel (10, 110) runs parallel to the center axis (A) of the combustion bowl (21, 121).

7. Piston according to claim 1, wherein at least one heat conducting element (32) is provided in the cooling channel (24, 124).

8. Piston according to claim 1, wherein a circumferential recess (15) is formed between the piston head (13, 113) and the piston skirt (14, 114), and wherein the cooling channel (24, 124) is closed off with a closure element (27, 127).

9. Piston according to claim 1, wherein the closure element (27, 127) is held on the piston ring element (12, 112) in the region of the ring belt (15, 115).
